(19) United States
(12) Patent Application Publication
(10) Pub. No.: US 2017/0053571 A1
(43) Pub. Date: Feb. 23, 2017

(54) BANNER ASSEMBLY AND METHOD

(71) Applicant: Mark Wormser, Ocala, FL (US)

(72) Inventor: Mark Wormser, Ocala, FL (US)

(21) Appl. No.: 15/341,635

(22) Filed: Nov. 2, 2016

Related U.S. Application Data
(63) Continuation of application No. 15/197,101, filed on Jun. 29, 2016.
(60) Provisional application No. 62/185,936, filed on Jun. 29, 2015.

(51) Int. Cl. G09F 15/00; G09F 17/00

(52) U.S. Cl. CPC G09F 15/0025; G09F 17/00

(57) ABSTRACT

A banner assembly includes a banner mounting frame having a plurality of releasably connected frame sections defining a banner mounting area therebetween. The plurality of releasably connected frame sections include at least a first side section and a second side section, the banner mounting frame being configured for connection to an underlying surface with the banner mounting area being held thereabove. A banner is mounted in the banner mounting area. A plurality of mounting cords are connected along peripheral edges of the banner and secured to the banner mounting frame. The mounting cords exert an engagement force between the side sections via the banner.

### CROSS-REFERENCE TO RELATED APPLICATION

This application is a continuation of U.S. patent application Ser. No. 15/197,101 filed on Jun. 29, 2016, which claims the benefit of U.S. Provisional Patent Application Ser. No. 62/185,936, filed on Jun. 29, 2015, the contents of which applications are herein incorporated by reference in their entirety.

### FIELD OF THE INVENTION

The present invention relates to advertising signs, and more particularly, to modular banner assemblies.

### BACKGROUND OF THE INVENTION

Advertisements, such as banners and other large signs often require professional installation. A common method of displaying a banner, for examples, is to mount it to a wall. Often, screws are driven through grommet holes of a banner into the wall surface, thereby affixing the banner to the wall. In such cases, it will be necessary to transport a large wall surface to the banner display location, and the mounting process will be labor intensive and time consuming.

Other assemblies feature purpose-built frames, but these can be expensive to build and ship and/or time-consuming and difficult to assemble at a desired location. Accordingly, further improvements are possible.

### SUMMARY OF THE INVENTION

In view of the foregoing, it is an object of the present invention to provide an improved banner assembly and display method. The banner assembly includes a banner mounting frame having a plurality of releasably connected frame sections defining a banner mounting area therebetween. The plurality of releasably connected frame sections include at least a first side section and a second side section, the banner mounting frame being configured for connection to an underlying surface with the banner mounting area being held thereabove. A banner is mounted in the banner mounting area. A plurality of mounting cords are connected along peripheral edges of the banner and secured to the banner mounting frame. The plurality of mounting cords includes at least a first mounting cord and a second mounting cord secured to the first side section and to the second side section. Exerting a connecting force through the first mounting cord, the banner and the second mounting cord pulls the first side section toward the second side section. Prior to connection to the underlying surface, the plurality of releasably connected frame sections are freely disconnectable except for the connecting force.

These and other objects, aspects and advantages of the present invention will be better appreciated in view of the drawing and following detailed description of preferred embodiments.

### BRIEF DESCRIPTION OF THE DRAWINGS

FIG. 1 is a front view of a banner assembly, including a banner mounting frame and a banner, according to an embodiment of the present invention;

FIG. 2 is a partially exploded view of the banner mounting frame of FIG. 1;

FIG. 3 is a perspective view of the banner mounting frame of FIG. 1, during a stage of assembly; and

FIGS. 4 and 5 are front views of larger and smaller banner assemblies, respectively, according to additional embodiments of the present invention.

### DETAILED DESCRIPTION OF THE PREFERRED EMBODIMENTS

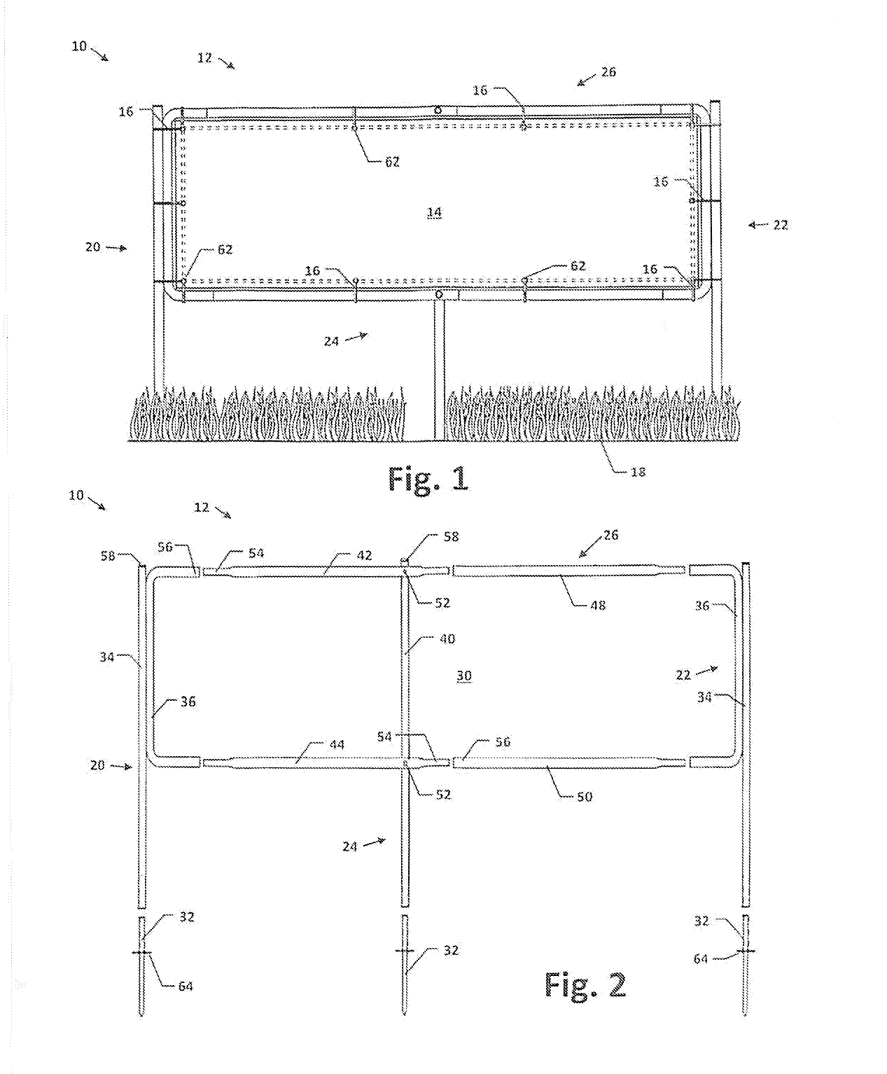

Referring to FIGS. 1 and 2, according to an embodiment of present invention, a banner assembly 10 includes a banner mounting frame 12 in which a banner 14 is held vertically by a plurality of mounting cords 16 over an underlying surface 18, such as the ground. The frame 12 is composed of a plurality of releasably connected frame sections 20, 22, 24, 26, which include first and second side sections 20, 22. The frame sections define a banner mounting area 30 in which the banner 14 is held by the cords 16. Advantageously, the frame sections are freely releasable absent engagement of the frame 12 with the underlying surface 18 except for an engagement force exerted between the first and second side sections 20, 22 by the mounting cords 16 via the banner 14. Stakes 32 are used to engage the frame 12 with the underlying surface 18.

In the depicted embodiment, the mounting frame 12 includes the first and second side sections 20, 22, an intermediate vertical support section 24 and an intermediate horizontal extension section 26. The side sections 20, 22 each include a vertical post 34 connected to a C-shaped bracket 36 having two horizontal ends. The intermediate vertical support section 24 includes a vertical post 40 connected to upper and lower horizontal cross-members 42, 44. The horizontal extension section 26 includes separate upper and lower horizontal members 48, 50.

The connections within the side and intermediate sections 20, 22, 24 can be made via welds, adhesives, threaded fasteners or the like. For example, threaded fasteners 52 can be used to connect the horizontal cross-members 42, 44 of the intermediate vertical support section 24 to the vertical post 40. To reduce packing/shipping volume, this connection could then be made by the end user prior to final assembly and placement of the banner assembly 10. Aluminum or other durable, lightweight metal is a preferred material for the frame sections.

As noted above, the sections 20, 22, 24, 26 are freely releasable from one another. Advantageously, abutting horizontal ends of the sections feature complementary male and female ends 54, 56 which are held in engagement by the engagement force exerted by the mounting cords 16 via the banner 14. To prevent rain intrusion, open ends of the vertical posts 34, 40 are sealed by end caps 58. Plastic or other suitable material could be used for the end caps 58.

The banner 14 includes a plurality of grommets 62 located around a peripheral edge thereof, through which the mounting cords 16 are routed. The mounting cords 16 are preferably elastic cords, also known as bungee cords, which are looped through the grommets and around adjacent portions of the banner mounting frame 12. The number of bungee cords is determined according to the size of the banner 14 to be mounted. Preferably, two cords 12 are used at each corner of the banner 14.

The mounting stakes 32 preferably include a pointed lower end for ease of insertion into the underlying surface 18. Upper ends of the stakes 32 are received within hollow lower ends of the vertical posts 34, 40. The stakes can be made of any suitably durable material, such as fiberglass. Washers 64 are arranged around the stakes 32 to prevent the lower ends of the posts 34, 40 from sinking into the underlying surface.

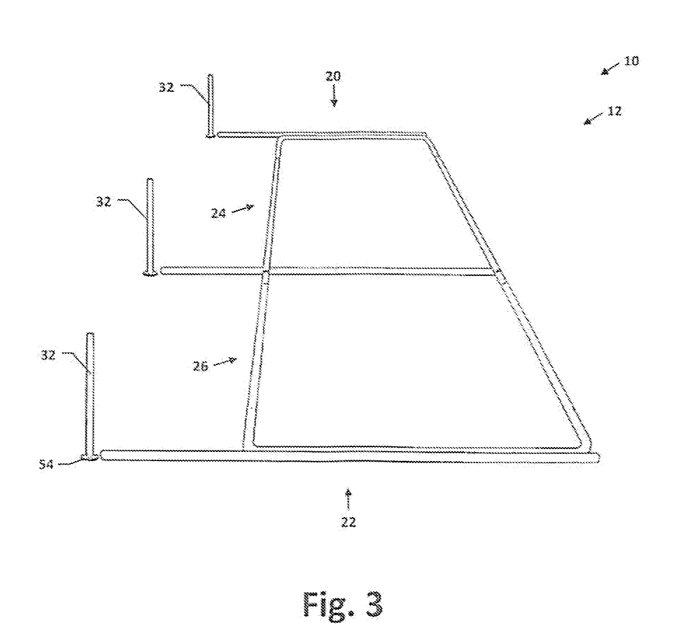

In use, referring also to FIG. 3, the frame sections 20, 22, 24, 26 are assembled together on the ground 18 in a desired location by mating the male and female horizontal ends 54, 56. Using the assembled mounting frame 12 as a guide, the stakes 32 are partially driven in the ground 18 and the washers 64 are placed therearound. The mounting frame 12 is then mounted vertically onto the stakes 32 and the banner 14 is attached in the banner mounting area 30 via the mounting cords 16.

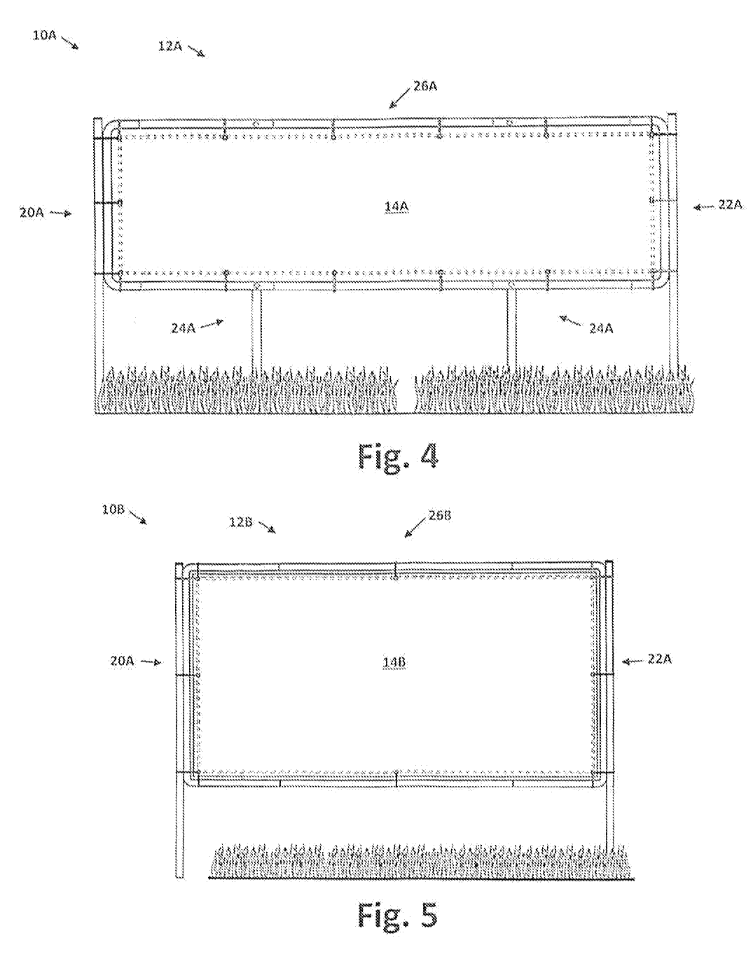

It will be appreciated that, in addition to the ease of manufacture and assembly offered by the banner assembly of the present invention, it can readily by configured to hold different sized banners. For example, the foregoing embodiment is dimensioned to hold a finished banner approximately 120 inches wide by 36 inches high within the banner mounting area 30 elevated approximately 16 inches over the underlying surface 18. Referring to FIGS. 4 and 5 (with like reference numerals referencing like components), by simply adjusting the number/configuration of frame sections 20-26A/B, different sized banners are accommodated. For example, the assembly 10A holds a banner 14A that is approximately 168 inches wide by 36 inches high, while the assembly 10B holds a banner 14B that is approximately 72 inches wide by 36 inches high.

The foregoing description of preferred embodiments is provided for illustrative and exemplary purposes; those skilled in the art will appreciated that the present invention is not necessarily limited thereto. Rather, those skilled in the art will appreciate that these and other modifications, as well as adaptations for particular circumstances, are possible within the scope of the invention herein shown and described, and of the appended claims.

What is claimed is:

1. A banner assembly comprising:
a banner mounting frame having a plurality of releasably connected frame sections defining a banner mounting area therebetween, the plurality of releasably connected frame sections including at least first and second side sections, the banner mounting frame being configured for connection to an underlying surface with the banner mounting area being held thereabove;
a banner mounted in the banner mounting area, the banner having a peripheral edge; and
a plurality of mounting cords being connected along the peripheral edge of the banner and secured to the banner mounting frame, the plurality of mounting cords including at least first and second mounting cords secured to the first and second side sections such that a connecting force exerted through the first mounting cord, the banner and the second mounting cord urges the first side section toward the second side section;
wherein, prior to connection to the underlying surface, the plurality of releasably connected frame sections are freely disconnectable except for the connecting force.

2. The banner assembly of claim 1, wherein the plurality of releasably connected frame sections further include at least one intermediate vertical support section between the first and second side sections, the at least one intermediate vertical support section including a vertical post and top and bottom horizontal cross-members, the top and bottom horizontal members extending in parallel between the first and second side sections.

3. The banner assembly of claim 1, wherein the plurality of releasably connected frame sections further include at least one horizontal extension section between the first and second side sections, the at least one horizontal extension section including separate upper and lower horizontal members.

4. The banner assembly of claim 3, wherein the plurality of releasably connected frame sections further include at least one intermediate vertical support section between the first and second side sections adjacent to the at least one horizontal extension section, the at least one intermediate vertical support section including a vertical post and top and bottom horizontal cross-members, the top and bottom horizontal members extending in parallel between the first and second side sections.

5. The banner of assembly of claim 1, wherein the first and second side sections each include a vertical post and a C-shaped bracket having two horizontal ends.

6. The banner assembly of claim 1, wherein abutting horizontal ends of the plurality of releasably connected frame sections are complementary male and female ends.

7. The banner assembly of claim 1, wherein the banner includes a plurality of grommets located along the peripheral edge, each of the plurality of mounting cords being routed through one of the plurality of grommets.

8. The banner assembly of claim 1, wherein the plurality of mounting cords are bungee cords.

9. The banner assembly of claim 1, further comprising a plurality of stakes engaging the banner mounting frame with the underlying surface.

10. The banner assembly of claim 9, wherein the plurality of stakes include at least first and second stakes respectfully received in lower ends of vertical posts of the first and second side sections.

11. The banner assembly of claim 10, further comprising a plurality of washers, each of the plurality of stakes having one of the plurality of washers arranged thereabout.

12. The banner assembly of claim 1, wherein the banner is approximately 36 inches high.

13. The banner assembly of claim 12, wherein the banner is approximately 72 inches wide.

14. The banner assembly of claim 12, wherein the banner is approximately 120 inches wide.

15. The banner assembly of claim 12, wherein the banner is approximately 168 inches wide.

16. A method of using a banner mounting assembly comprising:
assembling a plurality of releasably connected frame sections on an underlying surface to form a banner mounting frame in a horizontal orientation, the releasably connected frame sections being freely disconnectable and defining a banner mounting area therebetween;
raising the banner mounting frame into a vertical orientation and engaging the banner mounting frame to the underlying surface; and
connecting a banner in the banner mounting area using a plurality of mounting cords.

17. The method of claim 16, wherein the plurality of releasably connected frame sections include at least first and second side sections, and engaging the banner mounting to the underlying surface includes placing open lower ends of vertical posts of first and second side sections over upper ends of stakes partially inserted in the underlying surface.

18. The method of claim 17, wherein the plurality of mounting cords include at least first and second mounting cords attached to first and second ends of the banner, respectively, and connecting the banner in the banner mounting area includes securing the first and second mounting cords around the first and second side sections, respectively, such that an engagement force is exerted between the first and second side sections by the first and second mounting cords via the banner.

19. A banner assembly comprising:
a banner mounting frame having a plurality of releasably connected frame sections defining a banner mounting area therebetween, the plurality of releasably connected frame sections including first and second side sections and at least one intervening section arranged therebetween, the banner mounting frame being configured for connection to an underlying surface with the banner mounting area being held thereabove;
a banner mounted in the banner mounting area, the banner having a peripheral edge holding a plurality of grommets; and
a plurality of mounting cords being connected along the peripheral edge of the banner to the plurality of grommets and secured to the banner mounting frame, the plurality of mounting cords including at least first and second mounting cords secured to the first and second side sections such that a connecting force exerted through the first mounting cord, the banner and the second mounting cord urges the first side section toward the second side section, holding the at least one intervening section securely therebetween;
wherein, prior to connection to the underlying surface, the plurality of releasably connected frame sections are freely disconnectable except for the connecting force.

20. The banner assembly of claim 19, wherein the at least one intervening section includes at least one of:
a horizontal extension section including separate upper and lower horizontal members; and
an intermediate vertical support section including a vertical post and top and bottom horizontal cross-members.
